(19) United States
(12) Patent Application Publication
(10) Pub. No.: US 2024/0243511 A1
(43) Pub. Date: Jul. 18, 2024

(54) CONNECTOR

(71) Applicant: YAZAKI CORPORATION, Tokyo (JP)

(72) Inventors: Satoki Masuda, Makinohara-shi (JP); Yoshinao Sato, Kakegawa-shi (JP)

(21) Appl. No.: 18/398,137

(22) Filed: Dec. 27, 2023

(30) Foreign Application Priority Data
Jan. 16, 2023 (JP) 2023-004269

(51) Int. Cl. H01R 13/516; H01R 13/52

(52) U.S. Cl. CPC H01R 13/516; H01R 13/5205

(57) ABSTRACT

A connector includes: a housing includes a fitting part that is formed protruding toward a connection direction with respect to a connection target and inserted into a fitting hole; and a seal member that comes in contact with an inner face of the fitting hole to stop water between the housing and the connection target. The housing has an abutting part that extends from a base part side of the fitting part and abuts against an end part of the seal member. The abutting part has a corner part between an opposing face opposing to the outer periphery of the fitting part and a top end face chamfered. The seal member includes a third lip that protrudes from an outer periphery, and a flat part extending flat along the connection direction is formed between the third lip and the end part.

### CROSS-REFERENCE TO RELATED APPLICATION(S)

The present application claims priority to and incorporates by reference the entire contents of Japanese Patent Application No. 2023-004269 filed in Japan on Jan. 16, 2023.

### BACKGROUND OF THE INVENTION

### 1. Field of the Invention

The present invention relates to a connector.

### 2. Description of the Related Art

Conventionally, there is a connector as disclosed in Japanese Patent Application Laid-open No. 2022-032605, for example, that is equipped with an annular seal member (water sealing member) attached to a housing so that the seal member stops water between the housing and a connection target (mating device).

Such a connector has room for improvement in that it may have difficulty connecting to a connection target. For example, a connector is connected to a connection target by moving a seal member while in contact with a fitting part of the connection target. At this time, in a case where the coefficient of friction between the seal member and the fitting part is high or the like, a large insertion force is required to connect the connector, and connection of the connector to the connection target may not be achieved smoothly.

### SUMMARY OF THE INVENTION

It is therefore an object of the present invention to provide a connector capable of achieving connection to a connection target smoothly.

In order to achieve the above mentioned object, a connector according to one aspect of the present invention includes a housing that holds a terminal connected to a connection target, the housing including a fitting part that is formed protruding toward a connection direction with respect to the connection target and inserted into a fitting hole formed in the connection target; and a seal member that is attached to an outer periphery of the fitting part, the seal member coming in contact with an inner face of the fitting hole to stop water between the housing and the connection target, wherein the housing has an abutting part that extends from a base part side of the fitting part and abuts against an end part of the seal member, the abutting part is formed by being spaced apart from the outer periphery of the fitting part, the abutting part having a corner part between an opposing face opposing to the outer periphery of the fitting part and a top end face chamfered, and the seal member includes a lip that protrudes from an outer periphery, and a flat part extending flat along the connection direction is formed in an outer periphery face between the lip and the end part.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a connector according to an embodiment;

FIG. 2 is an exploded perspective view illustrating the connector according to the embodiment;

FIG. 3 is a sectional view of a seal member of the connector taken along III-III line in FIG. 1;

FIG. 4 is an explanatory diagram when connecting the connector according to the embodiment;

FIG. 5 is an explanatory diagram when connecting the connector according to the embodiment;

FIG. 6 is an explanatory diagram of a comparative example; and

FIG. 7 is a graph indicating the insertion forces with respect to the insertion positions when connecting the connector according to the embodiment.

### DETAILED DESCRIPTION OF THE PREFERRED EMBODIMENTS

Hereinafter, an embodiment according to the present invention will be described in detail with reference to the accompanying drawings. Note, however, that the present invention is not limited by the embodiment. Furthermore, structural components in the following embodiment include those that can be easily replaced by those skilled in the art, or those that are substantially the same.

### Embodiment

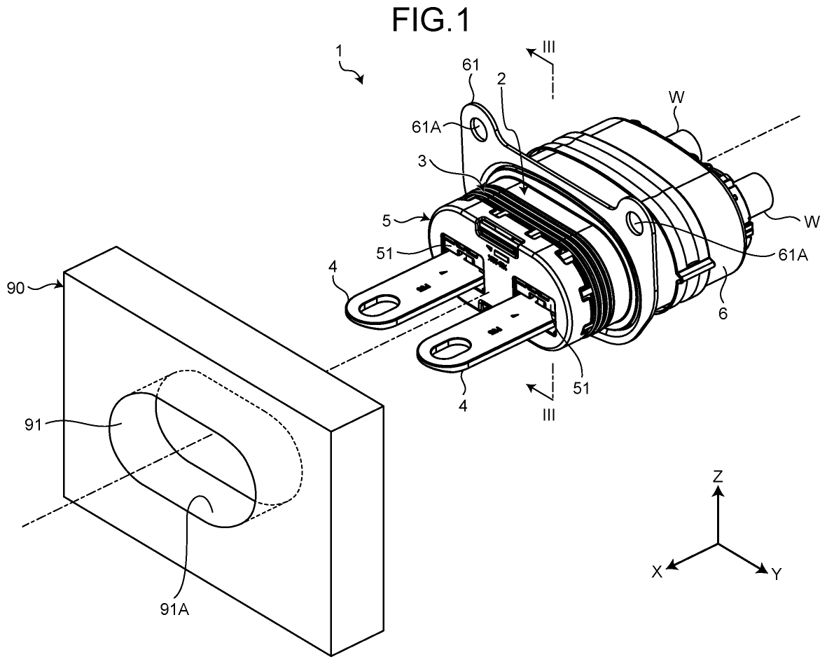

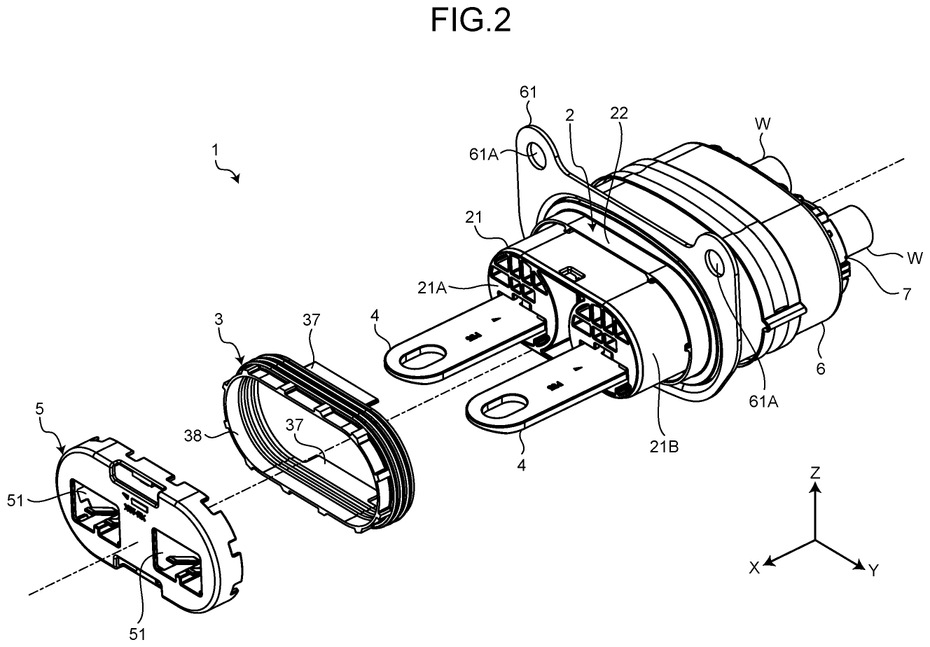

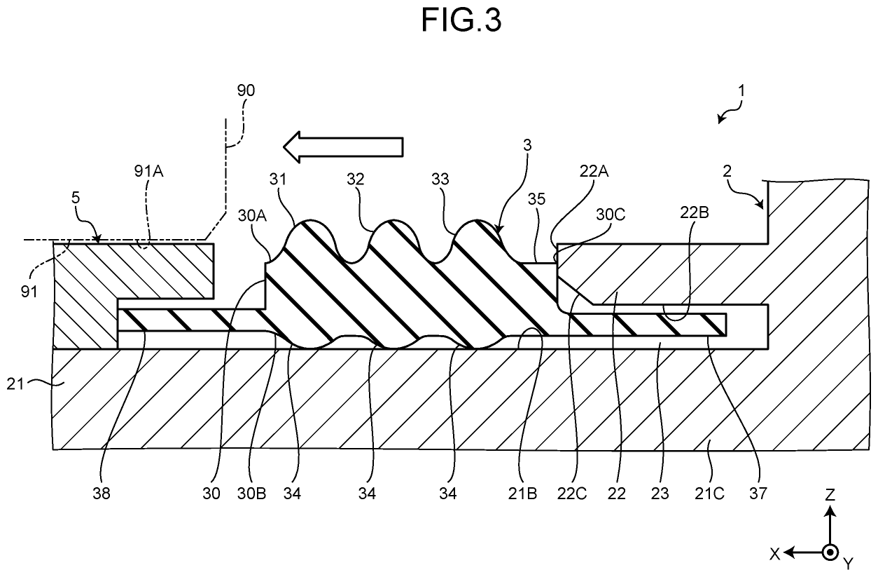

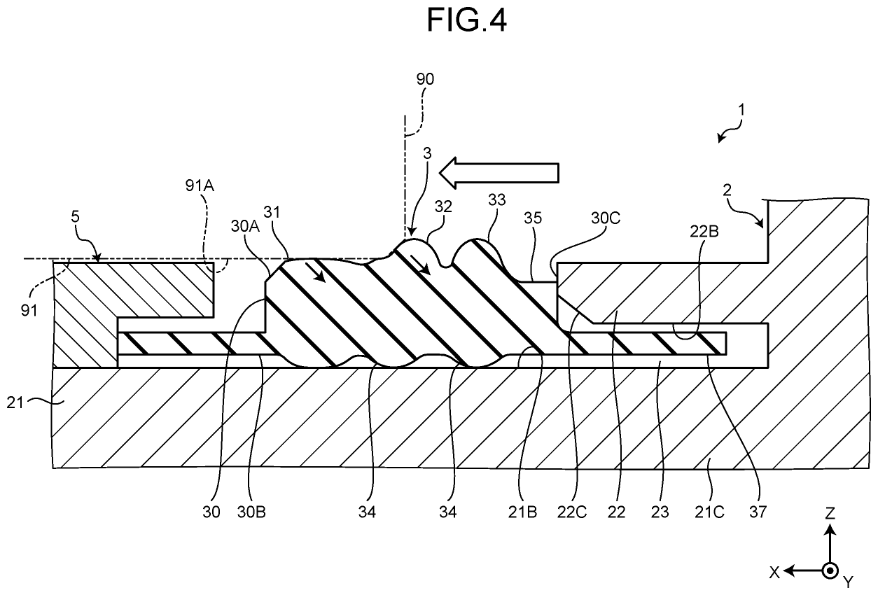

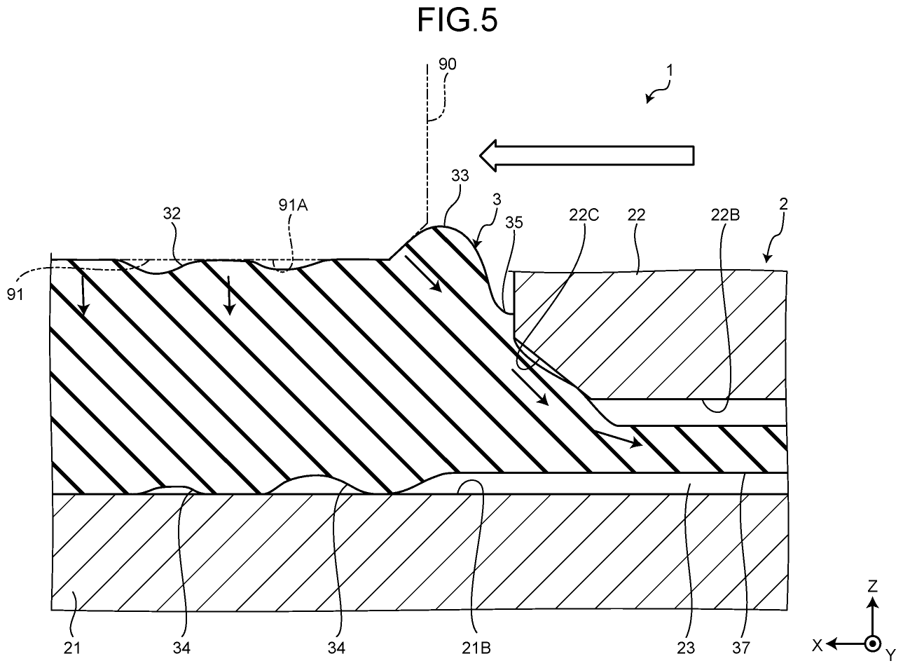

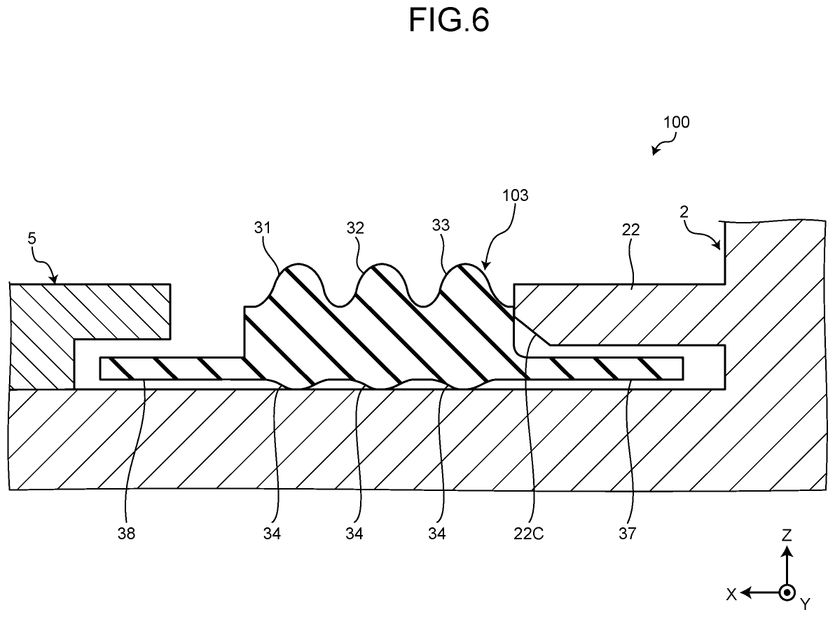

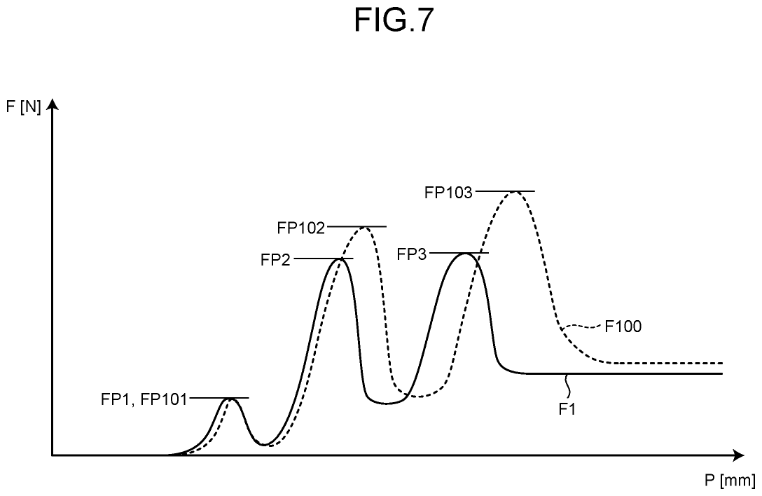

The present embodiment relates to a connector. FIG. 1 is a perspective view illustrating a connector according to the embodiment. FIG. 2 is an exploded perspective view illustrating the connector according to the embodiment. FIG. 3 is a sectional view of a seal member of the connector taken along III-III line in FIG. 1. FIG. 4 is an explanatory diagram when connecting the connector according to the embodiment. FIG. 5 is an explanatory diagram when connecting the connector according to the embodiment. FIG. 6 is an explanatory diagram of a comparative example. FIG. 7 is a graph indicating the insertion forces with respect to the insertion positions when connecting the connector according to the embodiment.

In the description hereinafter, in regards to a first direction, a second direction, and a third direction intersecting with each other, the first direction is referred to as a “connection direction X”, the second direction as a “width direction Y”, and the third direction as a “height direction Z”. Herein, the connection direction X, the width direction Y, and the height direction Z are orthogonal to each other. The connection direction X corresponds to the connection direction between the connector and a connection target and the insertion direction of a fitting part of the connector with respect to the connection target. The width direction Y and the height direction Z correspond to intersecting directions that intersect with the connection direction X. Furthermore, unless otherwise noted, each of the directions used in the following description represents the direction in a state where components are mounted to each other. Note that orthogonal herein includes almost orthogonal.

As illustrated in FIG. 1, a connector 1 is a connection component used for connection to a connection target 90, and it includes a housing 2 and a seal member 3. The connector 1 is used by being loaded on a vehicle, for example.

The housing 2 is a member that holds a terminal 4 to be connected to the connection target 90, and includes a fitting part 21 that is inserted into a fitting hole 91 formed in the connection target 90. The housing 2 holds two terminals 4 lined in the width direction Y, for example, with the terminals 4 extending out from a top end face 21A of the fitting part 21 toward the connection direction X. Each of the terminals 4 is attached to a wire W in the housing 2. The fitting part 21 is a part extending out toward the connection target 90 side along the connection direction X and is formed in accordance with the shape of the fitting hole 91 that has a long cross-sectional shape in the width direction Y such as an elliptical or oval cross-sectional shape, for example.

The connection target 90 is a device to be connected to the connector 1, which corresponds to an electrical device, a power supply, and the like, for example. The connection target 90 may also be a mating connector that is attached to an electrical device, a power supply, and the like. For convenience of explanation, FIG. 1 illustrates the connection target 90 with part of the outer wall being a cuboid shape. The fitting hole 91 is a hole for inserting the terminals 4 and the fitting part 21, and it is formed to have an elliptical or oval shaped cross section in the direction intersecting with the connection direction X, for example.

For example, a surface treatment for anti-rusting may be applied on an inner face 91A of the fitting hole 91. Specifically, in a case where the part forming the fitting hole 91 in the connection target 90 is formed with a metal having aluminum as the main component, anodizing may be performed on the inner face 91A of the fitting hole 91. Anodizing is a treatment that forms an oxide film on the inner face 91A. In this case, the fitting hole 91 becomes less likely to rust, and the connection state of the connector 1 is maintained in good condition. However, anodizing increases the surface roughness of the inner face 91A, which results in roughening the surface of the inner face 91A. It is concerned that this may worsen the sliding property between the fitting hole 91 and the seal member 3, and increase the insertion force when connecting the connector 1.

The seal member 3 is attached to the outer periphery of the fitting part 21. The seal member 3 is a water sealing member or a packing that stops water between the housing 2 and the connection target 90, and it is formed in an annular shape. The seal member 3 is formed with an elastic member that is elastically deformable. Details of the seal member 3 will be described later.

As illustrated in FIG. 2, the connector 1 includes a front holder 5, a shield shell 6, and a rear holder 7. The front holder 5 is a holding member that holds the seal member 3, and has an insertion hole 51 for inserting the terminal 4. The insertion hole 51 is formed in accordance with the number of provided terminals 4, and there are two formed herein, for example. The front holder 5 is attached at the tip position of the fitting part 21, and prevents the seal member 3 from coming off from the fitting part 21. The shield shell 6 is a cover member or a case member covering the housing 2, and covers the outer peripheral part of the housing 2 except for the fitting part 21. The shield shell 6 is formed with a metal, for example, and functions as an electromagnetic shield. The shield shell 6 has a flange part 61. The flange part 61 is a plate-like part extending in a direction intersecting with the connection direction X, and has fastening holes 61A used for being fastened to the connection target 90. The rear holder 7 is a member attached to the rear part of the housing 2, and holds a packing (not illustrated) that is attached to the wire W.

As illustrated in FIG. 3, the seal member 3 is attached to the outer periphery of the fitting part 21. The seal member 3 illustrated in FIG. 3 is in a state before the fitting part 21 is inserted into the connection target 90. The seal member 3 has lips protruding from the outer periphery. For example, three lips that are a first lip 31, a second lip 32, and a third lip 33 are formed along the connection direction X. The first lip 31, the second lip 32, and the third lip 33 are formed in the order of the first lip 31, the second lip 32, and the third lip 33 from the tip side of the fitting part 21, and come in contact with the connection target 90 in this order when the connector 1 is connected to the connection target 90. The first lip 31, the second lip 32, and the third lip 33 are formed in line along the outer periphery of the seal member 3, and each of the lips is formed to have a mountain-shaped cross section along the connection direction X, for example.

The first lip 31, the second lip 32, and the third lip 33 are formed on a main body part 30 of the seal member 3, and provided to protrude on an outer peripheral face 30A of the main body part 30. The main body part 30 is the main body of the seal member 3, and has a cylindrical shape with a rectangular cross section. An inner periphery lip 34 is formed on an inner peripheral face 30B of the main body part 30, and it is in contact with an outer peripheral face 21B of the fitting part 21. There are three inner periphery lips 34, for example, which are formed at inside positions corresponding to the first lip 31, the second lip 32, and the third lip 33.

A flat part 35 is formed on the outer peripheral face 30A of the main body part 30. The flat part 35 is formed between the third lip 33 and an end part 30C of the main body part 30. The flat part 35 is an area extending flat along the connection direction X on the outer peripheral face 30A, and it is a part to form a space for the clearance of the third lip 33 when the third lip 33 is deformed by contacting the connection target 90. The flat part 35 is formed with a straight surface in the cross section along the connection direction X, for example. The flat part 35 may also be an area with almost a flat surface, or it may have unevenness to the extent not significantly affecting the deformation of the third lip 33 and the insertion force of the connector 1, for example. The length of the flat part 35 formed in the connection direction X is half the length of the adjacent third lip 33, for example. The connector 1 has the flat part 35 formed between the third lip 33 and the end part 30C, which separates the third lip 33 from the end part 30C and allows deformation of the third lip 33 toward the end part 30C when connecting to the connection target 90, thereby reducing the insertion force required for the connector 1. Furthermore, by setting the length of the flat part 35 formed in the connection direction X to be about half the length of the adjacent third lip 33, the connector 1 can suppress the seal member 3 from becoming too long in the connection direction X while allowing deformation of the third lip 33. Note that half the length herein includes almost half the length.

The end part 30C of the main body part 30 abuts against an abutting part 22. The abutting part 22 is a part formed in the housing 2, and it extends from a base part 21C side of the fitting part 21 to the top end face 21A side and abuts against the end part 30C of the main body part 30. The abutting part 22 is formed by being spaced apart from the fitting part 21 in the radial direction of the fitting part 21 (in the height direction Z in FIG. 3), and it is formed in a cylindrical shape to surround the outer periphery of the fitting part 21, for example. A top end face 22A of the abutting part 22 abuts against the end part 30C of the main body part 30 on the base end side, which restricts the seal member 3 from moving in the connection direction X when coming in contact with the connection target 90.

A clearance space 23 is formed between the abutting part 22 and the fitting part 21. In other words, the space between an opposing face 22B of the abutting part 22 opposing to the fitting part 21 and the outer peripheral face 21B of the fitting part 21 is a void that functions as the clearance space 23 when the seal member 3 is deformed. That is, when the seal member 3 is pressed by contacting the connection target 90, the deformed part such as the main body part 30 or the third lip 33 enters the clearance space 23, thereby suppressing the seal member 3 from being strongly compressed.

The corner part between the opposing face 22B and the top end face 22A of the abutting part 22 is chamfered, and a tapered face 22C is formed in the corner part. The tapered face 22C is a face inclined with respect to the connection direction X, and it is a face for guiding the deformed part of the seal member 3 into the clearance space 23. In other words, when the seal member 3 is pressed by contacting the connection target 90, the formed tapered face 22C makes it easier for the deformed part such as the main body part 30 or the third lip 33 to enter the clearance space 23.

The seal member 3 has a first extension part 37 and a second extension part 38. The first extension part 37 and the second extension part 38 extend out from the main body part 30 in the connection direction X, and function as the parts for supporting the seal member 3. For example, the first extension part 37 extends out from the main body part 30 to the opposite side of the connection target 90, and it is provided by being inserted into the clearance space 23.

Therefore, the first extension part 37 formed therein suppresses the base end part of the seal member 3 from being rolled up. The second extension part 38 extends out from the main body part 30 toward the connection target 90, and it is provided by being inserted between the outer peripheral face 21B of the fitting part 21 and the front holder 5. Therefore, the second extension part 38 formed therein suppresses the top end part of the seal member 3 from being rolled up.

Next, connection of the connector 1 according to the present embodiment will be described.

As illustrated in FIG. 1, when connecting the connector 1 to the connection target 90, first, the connector 1 is disposed to face the connection target 90. In other words, the connector 1 is disposed with the terminals 4 and the fitting part 21 facing the fitting hole 91 of the connection target 90. Then, the connector 1 is brought closer to the connection target 90, the terminals 4 are inserted into the fitting hole 91, and then, as illustrated in FIG. 3, the fitting part 21 is inserted into the fitting hole 91.

As illustrated in FIG. 4, when the fitting part 21 is inserted into the fitting hole 91, the seal member 3 moves toward the connection direction X while contacting the inner face 91A of the fitting hole 91. Specifically, in the seal member 3, the first lip 31 first comes in contact with the inner face 91A. The first lip 31 has the mountain shape crushed and is deformed toward the second lip 32 side by being pressed by the inner face 91A, and it is closely fitted to the inner face 91A. When the fitting part 21 is inserted into the fitting hole 91 further, the second lip 32 comes in contact with the inner face 91A. The second lip 32 has the mountain shape crushed and is deformed toward the third lip 33 side by being pressed by the inner face 91A, and it is closely fitted to the inner face 91A.

Then, as illustrated in FIG. 5, when the fitting part 21 is further inserted deeper into the fitting hole 91, the third lip 33 comes in contact with the inner face 91A. The third lip 33 is pressed by the inner face 91A and is to deform toward the abutting part 22 side. At this time, the flat part 35 is formed on the abutting part 22 side of the third lip 33. Therefore, the third lip 33 is allowed to be deformed toward the abutting part 22 side. That is, the third lip is deformed toward the flat part 35 side without being greatly compressed.

Furthermore, as the fitting part 21 is inserted deeper into the fitting hole 91, the third lip 33 has the mountain shape crushed and is deformed toward the abutting part 22 side and the outer peripheral face 21B side of the fitting part 21. At this time, the tapered face 22C is formed on the abutting part 22. Therefore, the third lip 33 abuts against the abutting part 22 and is deformed by being guided toward the tapered face 22C side to distribute the pressure to be applied, thereby suppressing it from being greatly compressed. Therefore, with the connector 1 according to the present embodiment, it is possible to suppress the increase in the insertion force when connecting to the connection target 90 and to achieve connection to the connection target 90 smoothly. When the insertion of the fitting part 21 into the fitting hole 91 is completed, connection of the connector 1 to the connection target 90 is completed.

FIG. 6 illustrates a connector 100 to be a comparative example. The connector 100 is different from the connector 1 according to the present embodiment in respect that it has a seal member 103 that has no flat part 35 formed therein. That is, in the seal member 103, the first lip 31, the second lip 32, and the third lip 33 are formed without the flat part 35, and the third lip 33 abuts against the abutting part 22.

Compared to the connector 1 according to the present embodiment, the connector 100 requires a larger insertion force when connecting to the connection target 90. That is, deformation of the third lip 33 is regulated when the third lip 33 comes in contact with the connection target 90, thereby increasing the insertion force at that time.

FIG. 7 illustrates the insertion forces of the connector 1 according to the present embodiment and the connector 100 of the comparative example when connecting to the connection target 90. The horizontal axis in FIG. 7 indicates insertion positions P of the connectors, and the vertical axis indicates insertion forces F at the insertion positions P. Note that F1 in FIG. 7 represents the insertion force of the connector 1 according to the present embodiment, and F100 represents the insertion force of the connector 100 of the comparative example.

In FIG. 7, when each of the connector 1 according to the present embodiment and the connector 100 of the comparative example is connected to the connection target 90, the first lip 31 first comes in contact with the inner face 91A of the fitting hole 91. A peak value FP1 of the insertion force of the connector 1 and a peak value FP101 of the insertion force of the connector 100 at this time are almost the same magnitude. Then, when the connection to the connection target 90 proceeds and the second lip 32 comes in contact with the inner face 91A, a peak value FP102 of the insertion force of the connector 100 becomes slightly larger than a peak value FP2 of the insertion force of the connector 1. This is assumed to be because the second lip 32 is less likely to be deformed toward the abutting part 22 side, since the flat part 35 is not formed in the connector 100.

Then, when the connection to the connection target 90 further proceeds and the third lip 33 comes in contact with the inner face 91A, a peak value FP103 of the insertion force of the connector 100 becomes larger than a peak value FP3 of the insertion force of the connector 1. This is because the third lip 33 is pressed against the abutting part 22 and deformation thereof is regulated since the flat part 35 is not formed in the connector 100. Herein, the peak value FP103 of the insertion force of the connector 100 is about 1.4 times the peak value FP3 of the insertion force of the connector 1. As described, it is confirmed that the connector 1 according to the present embodiment can reduce the insertion force when connecting to the connection target 90 compared to the connector 100 of the comparative example, because of the flat part 35 formed in the seal member 3.

As described above, the connector 1 according to the present embodiment has the corner part of the abutting part 22 chamfered and the flat part 35 formed in the seal member 3, thereby allowing deformation of the third lip 33 when connecting to the connection target 90. Therefore, with the connector 1 according to the present embodiment, it is possible to suppress the increase in the insertion force when connecting to the connection target 90 and to achieve connection to the connection target 90 smoothly.

Furthermore, the connector 1 according to the present embodiment can reduce the insertion force for the connection target 90 even when a surface treatment for anti-rusting is applied on the inner face 91A of the fitting hole 91 of the connection target 90, so that connection to the connection target 90 can be achieved smoothly.

Note that the connector according to the present invention is not limited to the embodiment described above, and various changes are possible within the scope of the appended claims. Furthermore, the connector 1 according to the present embodiment may be configured by combining the structural components of the embodiment described above as appropriate.

For example, while the connector 1 according to the present embodiment is described above by referring to the case where the seal member 3 includes the first lip 31, the second lip 32, and the third lip 33, the number of lips provided therein may also be one, two, or four or more. With such connectors, the same effects as those of the connector 1 according to the embodiment described above can be acquired. In other words, the connector with the corner part of the abutting part 22 being chamfered and the flat part 35 being formed in the seal member 3 can suppress the increase in the insertion force required when connecting to the connection target 90, which makes it possible to achieve connection to the connection target 90 smoothly.

Furthermore, while the case of loading the connector 1 according to the embodiment above on a vehicle is described, it may also be used without being loaded on a vehicle.

According to the connector of the present embodiment, connection to the connection target can be achieved smoothly.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A connector comprising:
a housing that holds a terminal connected to a connection target, the housing including a fitting part that is formed protruding toward a connection direction with respect to the connection target and inserted into a fitting hole formed in the connection target; and
a seal member that is attached to an outer periphery of the fitting part, the seal member coming in contact with an inner face of the fitting hole to stop water between the housing and the connection target, wherein
the housing has an abutting part that extends from a base part side of the fitting part and abuts against an end part of the seal member,
the abutting part is formed by being spaced apart from the outer periphery of the fitting part, the abutting part having a corner part between an opposing face opposing to the outer periphery of the fitting part and a top end face chamfered, and
the seal member includes a lip that protrudes from an outer periphery, and a flat part extending flat along the connection direction is formed in an outer periphery face between the lip and the end part.

2. The connector according to claim 1, wherein
a surface treatment for anti-rusting is applied on the inner face of the fitting hole.
